(19) United States
(12) Patent Application Publication
(10) Pub. No.: US 2026/0014879 A1
(43) Pub. Date: Jan. 15, 2026

(54) ENERGY STORAGE DEVICE AND ENERGY STORAGE SYSTEM

(71) Applicant: ISUZU MOTORS LIMITED, Yokohama-shi (JP)

(72) Inventor: Shinya BEPPU, Fujisawa-shi (JP)

(21) Appl. No.: 19/229,724

(22) Filed: Jun. 5, 2025

(30) Foreign Application Priority Data
Jul. 10, 2024 (JP) 2024-111023

(51) Int. Cl. B60L 50/60; B60L 7/10; B60L 58/12; H01M 10/46; H01M 50/209; H01M 50/249; H02J 7/00

(52) U.S. Cl. CPC B60L 50/60; B60L 7/10; B60L 58/12; H01M 10/46; H01M 50/209; H01M 50/249; H02J 7/0013; H02J 7/0047; B60L 2250/28; H01M 2220/20

(57) ABSTRACT

An energy storage device mounted in a moving body, the energy storage device including a plurality of thin-coated cells to which first active materials having thicknesses within a first range are applied between a current collector and a separator, and a plurality of thick-coated cells to which second active materials having thicknesses within a second range whose lower limit value is greater than an upper limit value of the first range, are applied between the current collector and the separator. The thin-coated cells and the thick-coated cells are alternately arranged at predetermined intervals.

### CROSS-REFERENCE TO RELATED APPLICATIONS

The present application claims priority to Japanese Patent Application number 2024-111023, filed on Jul. 10, 2024, contents of which are incorporated herein by reference in its entirety.

### BACKGROUND OF THE INVENTION

The present disclosure relates to an energy storage device and an energy storage system. A conventional electric vehicle includes lithium-ion batteries as a large-capacity energy storage device and a capacitor as a large-output energy storage device (e.g., Japanese Unexamined Patent Application Publication No. 2010-41847).

In the lithium-ion batteries, an increase in the thickness of the active material applied to the current collector enhances energy density but reduces output characteristics. Conversely, in the lithium-ion batteries, a decrease in the active material thickness applied to the current collector lowers energy density while improving output characteristics. Therefore, when an energy storage device configured solely with lithium-ion batteries is mounted in a vehicle, a problem arises in that high energy density and high output characteristics cannot be achieved at the same time.

### BRIEF SUMMARY OF THE INVENTION

The present disclosure has been made in view of these points, and its object is to improve both energy density and output characteristics.

An energy storage device according to a first aspect of the present disclosure is mounted in a moving body, the energy storage device including: a plurality of first cells to which first active materials having thicknesses within a first range are applied between a current collector and a separator; and a plurality of second cells to which second active materials having thicknesses within a second range whose lower limit value is greater than an upper limit value of the first range, are applied between the current collector and the separator, wherein the first cells and the second cells are alternately arranged at predetermined intervals.

An energy storage system according to a second aspect of the present disclosure including: an energy storage device, which includes lithium-ion batteries and is mounted in a moving body; and an energy storage control device that controls charging and power supply of the energy storage device, wherein the energy storage device may include: a plurality of first cells to which first active materials having thicknesses within a first range are applied between a current collector and a separator; and a plurality of second cells to which second active materials having thicknesses within a second range, whose lower limit value is greater than an upper limit value of the first range, are applied between the current collector and the separator, among which the first cells and the second cells are alternately arranged at predetermined intervals, and the energy storage control device may include: an acquisition unit that acquires state information indicating a state of the moving body, a first state of charge of the plurality of first cells, and a second state of charge of the plurality of second cells; and a power control unit that controls (i) charging of the plurality of first cells and the plurality of second cells and (ii) supply of electric power to a drive source of the moving body, on the basis of at least one of the state information, the first state of charge, or the second state of charge.

### BRIEF DESCRIPTION OF THE DRAWINGS

FIG. 1 is a diagram illustrating an overview of a moving body S according to the present embodiment.

FIG. 2 is a cross-sectional view of a laminated structure of a thin-coated cell 21 and a thick-coated cell 22.

FIG. 3 is a diagram showing an arrangement of the thin-coated cells 21 and the thick-coated cells 22.

FIG. 4 is a diagram illustrating an example of a processing sequence in an energy storage device 10.

### DETAILED DESCRIPTION OF THE INVENTION

Hereinafter, the invention will be described through embodiments of the invention. The below embodiments, however, are not intended to limit the invention according to the claims, and all combinations of features described in the embodiments are not necessarily essential to the solutions of the invention.

### Overview of a Moving Body S

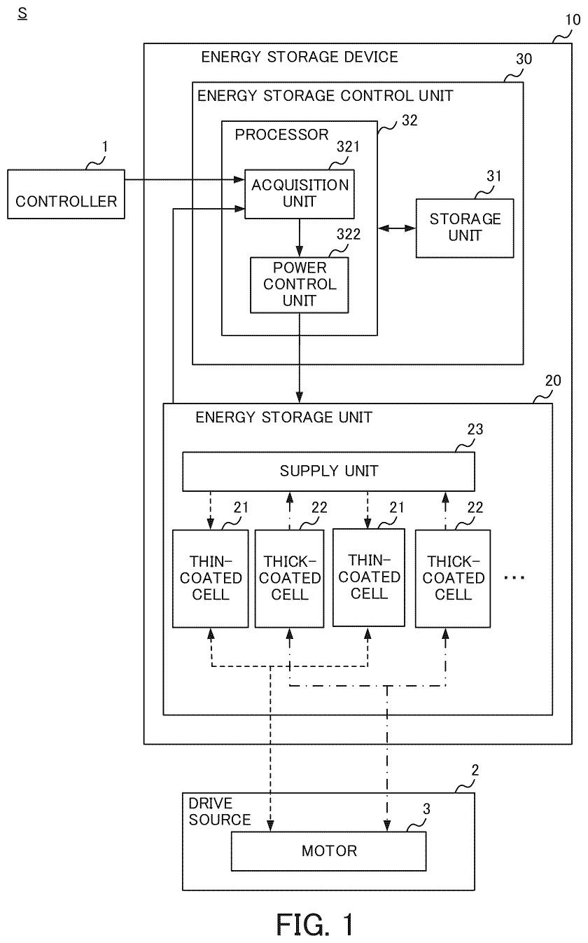

FIG. 1 is a diagram illustrating an overview of a moving body S according to the present embodiment. The moving body S illustrated in FIG. 1 includes a controller 1, a drive source 2, and an energy storage device 10. The moving body S is a moving body that uses mechanical energy generated by the drive source 2, which includes an electric motor (motor 3), as its motive power, and is, for example, an electric vehicle (EV).

The controller 1 is a device including a processor such as a CPU (Central Processing Unit) or an ECU (Electronic Control Unit), and accepts operations from a user of the moving body S to control the operation of a device corresponding to the operation, among a plurality of devices included in the moving body S. The user is a driver of the moving body S when the moving body S is the EV. As one example, when the controller 1 accepts an operation indicating that the user has depressed an accelerator pedal, it causes the moving body S to accelerate by supplying electric power from the energy storage device 10 to the drive source 2.

The drive source 2 is a power source that generates power for causing the moving body S to move, and includes the motor 3. The motor 3 is an electric motor that converts electric power supplied from the energy storage device 10 into mechanical energy and transmits the mechanical energy to a driving device (not shown) when the moving body S moves. The motor 3 generates regenerative electric power during deceleration of the moving body S and supplies the regenerative electric power to the energy storage device 10.

The energy storage device 10 is a device including a secondary battery such as lithium-ion batteries, and has functions of supplying electric power stored in the secondary battery to the drive source 2 and charging the secondary battery with regenerative electric power generated by the drive source 2 or electric power supplied through a charging port (not shown) of the moving body S. In FIG. 1, a plurality of thin-coated cells 21 (first cells) and a plurality of thick-coated cells 22 (second cells) are shown as the secondary batteries.

Since the moving body S requires a long cruising distance and high output, a secondary battery to be mounted in the moving body S is required to have high energy density and a high C-rate (charge/discharge rate). Since the C-rate is one of the output characteristics of the secondary battery, a high C-rate of the secondary battery means that the secondary battery has high output characteristics. However, in a secondary battery such as lithium-ion batteries, increasing the thickness of the active material applied between the current collector and the separator included in the cells increases the energy density, but lowers the C rate during charge and discharge. On the other hand, decreasing the thickness of the active material applied between the current collector and the separator increases the C rate during charge and discharge, but lowers the energy density. Therefore, although the secondary battery mounted in the moving body S is required to have both high energy density and high output characteristics, lithium-ion batteries used as the secondary battery in the moving body S cannot achieve both high energy density and high output characteristics at the same time.

Therefore, the energy storage device 10 includes a plurality of thin-coated cells 21 to which an active material is applied in a thin layer and a plurality of thick-coated cells 22 to which an active material is applied more thickly than in the thin-coated cells 21. The energy storage device 10 switches between supplying electric power from the thin-coated cells 21 to the drive source 2 and supplying electric power from the thick-coated cells 22 to the drive source 2, in accordance with an operation (for example, the depression speed of an accelerator pedal) by the user of the moving body S. By operating in this manner, the energy storage device 10 can supply electric power from the thin-coated cells 21 to the drive source 2 at a high C rate, and increase the energy density by including the thick-coated cells 22, thereby enabling both high energy density and high output characteristics to be achieved simultaneously.

### Configuration of the Energy Storage Device 10

As shown in FIG. 1, the energy storage device 10 includes an energy storage unit 20 and an energy storage control unit 30. The energy storage unit 20 includes the plurality of thin-coated cells 21, the plurality of thick-coated cells 22, and a supply unit 23. The energy storage control unit 30 includes a storage unit 31 and a processor 32. The processor 32 includes an acquisition unit 321 and a power control unit 322.

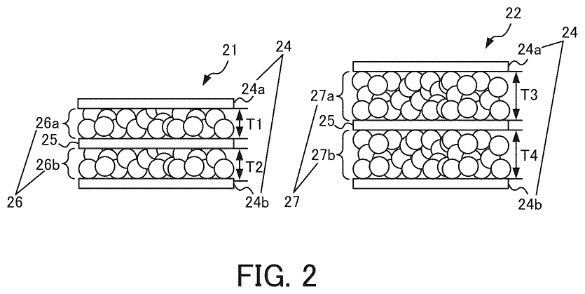

First, the configuration of the energy storage unit 20 will be described. FIG. 2 is a cross-sectional view of a laminated structure of a thin-coated cell 21 and a thick-coated cell 22. The thin-coated cell 21 includes current collectors 24 (a cathode current collector 24a and an anode current collector 24b) and a separator 25. For example, the cathode current collector 24a is aluminum foil, the anode current collector 24b is copper foil, and the separator 25 is made of a polyolefin resin.

The space between the cathode current collector 24a and the separator 25 of the thin-coated cell 21 contains (i) a cathode active material 26a, (ii) a polyvinylidene fluoride (PVDF) binder, and (iii) a conductive additive. The space between the anode current collector 24b and the separator 25 of the thin-coated cell 21 contains an anode active material 26b and an aqueous (water-soluble) binder. For example, the cathode active material 26a is lithium cobalt oxide, the conductive additive is carbon black, and the anode active material 26b is graphite.

In the thin-coated cell 21, first active materials 26 (the cathode active material 26a and the anode active material 26b) having thicknesses within a first range are applied between the current collectors 24 and the separator 25. The upper limit value of the first range is, for example, 100 μm. Specifically, in the thin-coated cell 21, the cathode active material 26a having a thickness T1 within the first range is applied between the cathode current collector 24a and the separator 25, and the anode active material 26b having a thickness T2 within the first range is applied between the anode current collector 24b and the separator 25. The thicknesses T1 and T2 may be the same or different.

The thick-coated cell 22 includes the current collectors 24 (the cathode current collector 24a and the anode current collector 24b) and the separator 25. For example, the cathode current collector 24a is aluminum foil, the anode current collector 24b is copper foil, and the separator 25 is made of a polyolefin resin. The space between the cathode current collector 24a and the separator 25 of the thick-coated cell 22 contains (i) a cathode active material 27a, (ii) a polyvinylidene fluoride (PVDF) binder, and (iii) a conductive additive, and the space between the anode current collector 24b and the separator 25 of the thick-coated cell 22 contains an anode active material 27b and an aqueous (water-soluble) binder. For example, the cathode active material 27a is lithium cobalt oxide, the conductive additive is carbon black, and the anode active material 27b is graphite.

In the thick-coated cell 22, second active materials 27 (the cathode active material 27a and the anode active material 27b) having thicknesses within a second range whose lower limit value is greater than the upper limit value of the first range, are applied between the current collectors 24 and the separator 25. As an example, when the upper limit of the first range is 100 μm, the second range is 110 μm or more and less than 200 μm. Specifically, in the thick-coated cell 22, the cathode active material 27a having a thickness T3 within the second range is applied between the cathode current collector 24a and the separator 25, and the anode active material 27b having a thickness T4 within the second range is applied between the anode current collector 24b and the separator 25. The thicknesses T3 and T4 may be the same or different.

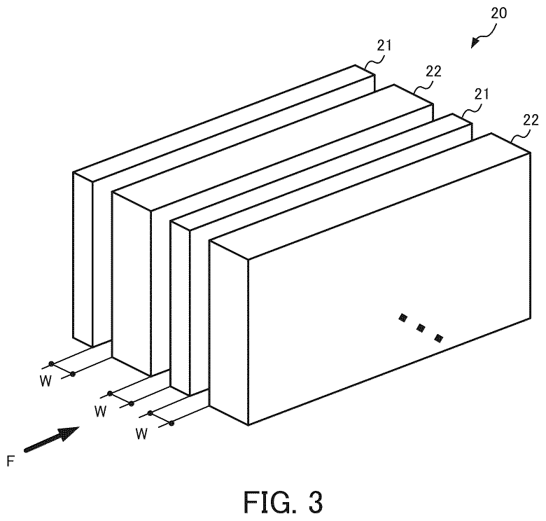

In the energy storage unit 20, the thin-coated cells 21 and the thick-coated cells 22 are alternately arranged at predetermined intervals. The predetermined interval is an interval formed by bonding each cell with an adhesive, and is, for example, 2 mm or more and 3 mm or less. FIG. 3 is a diagram showing the arrangement of the thin-coated cells 21 and the thick-coated cells 22. As shown in FIG. 3, in the energy storage unit 20, the thin-coated cells 21 and the thick-coated cells 22 are alternately arranged at predetermined intervals W when viewed from a direction F. Each interval W may be the same or different.

By alternately arranging the plurality of thin-coated cells 21 and the plurality of thick-coated cells 22 as described above, the energy storage device 10 can disperse heat generated during the supply of electric power from the thin-coated cells 21 or the thick-coated cells 22 to the drive source 2. In other words, the energy storage device 10 can suppress localized temperature increases (so-called temperature unevenness) within the energy storage device 10 and maintain a uniform internal temperature. As a result, it becomes easier to install the energy storage device 10 even in areas of the moving body S that tend to become hot, thereby facilitating greater flexibility in installation locations.

Returning to FIG. 1, the supply unit 23 includes, for example, a flyback converter, and supplies electric power from each thick-coated cell 22 to each thin-coated cell 21. By having the supply unit 23 operate in this manner, even when an SOC (State Of Charge) of the thin-coated cells 21 having a low energy density decreases, electricity can be supplied from the thick-coated cells 22 having a high energy density to the thin-coated cells 21. As a result, the energy storage device 10 can continuously supply electric power from the thin-coated cells 21 at a high C rate.

Next, the configuration of the energy storage control unit 30 will be described. The storage unit 31 includes, for example, a storage medium such as a read only memory (ROM), a random access memory (RAM), a hard disk drive (HDD), or a solid state drive (SSD). The storage unit 31 stores programs executed by the processor 32 and various types of information for the energy storage unit 20 to supply electric power to the drive source 2.

The processor 32 is a processor such as a CPU or an ECU. The processor 32 functions as the acquisition unit 321 and the power control unit 322 by executing the programs stored in the storage unit 31. The processor 32 may be configured by a single processor, or may be configured by a plurality of processors or a combination of one or more processors and an electronic circuit.

The acquisition unit 321 acquires state information indicating a state of the moving body S, a first state of charge of the plurality of thin-coated cells 21, and a second state of charge of the plurality of thick-coated cells 22. The state of the moving body S included in the state information is, for example, at least one of a state in which the accelerator pedal of the moving body S is depressed, a depression speed at which the driver depresses the accelerator pedal, or a state in which a regenerative brake of the moving body S is in operation. The acquisition unit 321 acquires the state information from the controller 1 at a predetermined interval, for example. The predetermined interval is, for example, 0.1 seconds. The acquisition unit 321 acquires the first state of charge and the second state of charge from the energy storage unit 20 at the predetermined interval, for example.

The power control unit 322 controls the supply of electric power to the drive source 2 of the moving body S on the basis of at least one of the state information, the first state of charge, or the second state of charge. For example, the power control unit 322 controls the supply of electric power to the moving body S at each timing when the acquisition unit 321 acquires the state information at the predetermined interval, until the predetermined interval has elapsed.

For example, on condition that the acquisition unit 321 has acquired state information indicating a depression speed at which the accelerator pedal of the moving body S is depressed, the power control unit 322 causes the plurality of thin-coated cells 21 to supply electric power to the drive source 2 when the depression speed exceeds a predetermined speed. The predetermined speed is a depression speed corresponding to the maximum value of the C rate of the plurality of thick-coated cells 22 and is stored in the storage unit 31. For example, when the depression speed included in the state information acquired by the acquisition unit 321 exceeds the predetermined speed stored in the storage unit 31, the power control unit 322 causes the plurality of thin-coated cells 21 to supply electric power to the drive source 2 at the C rate corresponding to the depression speed.

For example, on condition that the acquisition unit 321 has acquired state information indicating a depression speed at which the accelerator pedal of the moving body S is depressed, the power control unit 322 causes the plurality of thick-coated cells 22 to supply electric power to the drive source 2 when the depression speed is equal to or less than the predetermined speed stored in the storage unit 31. For example, when the depression speed included in the state information acquired by the acquisition unit 321 is equal to or less than the predetermined speed stored in the storage unit 31, the power control unit 322 causes the plurality of thick-coated cells 22 to supply electric power to the drive source 2 at the C rate corresponding to the depression speed.

By operating in this manner, the electric power control unit 322 can cause the thin-coated cells 21, which are capable of supplying electric power at a high C rate, to supply electric power when the depression speed is high, and can cause the thick-coated cells 22, which are capable of supplying electric power at a low C rate, to supply electric power when the depression speed is low. As a result, the power control unit 322 can cause the cells appropriate for the output required by moving body S to supply electric power to the drive source 2.

When the state in which electric power is supplied to the drive source 2 from one of the plurality of thin-coated cells 21 and the plurality of thick-coated cells 22 continues, there are cases where electric power is no longer supplied from the corresponding plurality of cells due to a decrease in their state of charge.

Therefore, when the state of charge of one of the plurality of cells has decreased, the power control unit 322 may cause the other plurality of cells to supply electric power to the drive source 2.

For example, when the acquisition unit 321 acquires the state information indicating the depression speed at which the accelerator pedal of the moving body S is depressed and the second state of charge is equal to or less than a first threshold value, the power control unit 322 causes the plurality of thin-coated cells 21 to supply electric power to the drive source 2 in accordance with the depression speed. The first threshold value is, for example, a fixed value of not less than 0% and less than 10%, and is stored in the storage unit 31. For example, even when the depression speed included in the state information acquired by the acquisition unit 321 is equal to or less than the predetermined speed, if the second state of charge is equal to or less than the first threshold value, the power control unit 322 causes the plurality of thin-coated cells 21 to supply electric power to the drive source 2 at a C rate corresponding to the depression speed.

For example, even when the depression speed included in the state information acquired by the acquisition unit 321 exceeds the predetermined speed, if the first state of charge is equal to or less than the first threshold value, the power control unit 322 causes the plurality of thick-coated cells 22 to supply electric power to the drive source 2. In this case, the plurality of thick-coated cells 22 supply electric power at the maximum C rate at which they are capable of supplying. That is, even when the depression speed of the accelerator pedal of the moving body S included in the state information exceeds the predetermined speed, if the first state of charge is equal to or less than the first threshold value, the power control unit 322 causes the plurality of thick-coated cells 22 to supply electric power to the drive source 2 at the maximum value of the outputs of the plurality of thick-coated cells 22. By operating in this manner, the power control unit 322 can continue the supply of electric power to the drive source 2 even when electric power cannot be supplied from the plurality of cells appropriate for the required output.

The power control unit 322 controls charging of the plurality of thin-coated cells 21 and the plurality of thick-coated cells 22 on the basis of at least one of the state information, the first state of charge, or the second state of charge. For example, the power control unit 322 controls charging of the plurality of thin-coated cells 21 and the plurality of thick-coated cells 22 at each timing when the acquisition unit 321 acquires the state information at the predetermined interval, until the predetermined interval has elapsed.

For example, on condition that the acquisition unit 321 has acquired state information indicating the state in which the regenerative brake of the moving body S is in operation, the power control unit 322 charges the plurality of thin-coated cells 21 with electric power generated by the regenerative brake when the first state of charge is less than the second threshold value. The second threshold value is, for example, a fixed value of 90% or more and 100% or less, and is stored in the storage unit 31.

For example, on condition that the acquisition unit 321 has acquired state information indicating the state in which the regenerative brake of the moving body S is in operation, the power control unit 322 charges the plurality of thick-coated cells 22 with the electric power when the first state of charge is equal to or greater than the second threshold value. By operating in this manner, the power control unit 322 can prioritize charging of the plurality of thin-coated cells 21, which have lower energy density than the plurality of thick-coated cells 22, with the regenerative energy generated by the motor 3. As a result, even when high output is frequently required by the moving body S, the energy storage device 10 is more likely to suppress a decrease in the first state of charge of the plurality of thin-coated cells 21.

Furthermore, the power control unit 322 may supply electric power from the plurality of thick-coated cells 22 to the plurality of thin-coated cells 21 in order to suppress the decrease in the first state of charge of the plurality of thin-coated cells 21. For example, on condition that the acquisition unit 321 has not acquired state information indicating the state in which the accelerator pedal of the moving body S is depressed or the state in which the regenerative brake of the moving body S is in operation, the power control unit 322 charges the plurality of thin-coated cells 21 by supplying electric power from the plurality of thick-coated cells 22 to the plurality of thin-coated cells 21. That is, when it is identified that the accelerator pedal of the moving body S is not depressed and that the motor 3 is not generating regenerative energy, the electric power control unit 322 supplies electric power from the plurality of thick-coated cells 22 to the plurality of thin-coated cells 21.

For example, when the first state of charge is less than the second threshold value, the power control unit 322 charges the plurality of thin-coated cells 21 by supplying electric power from the plurality of thick-coated cells 22 to the plurality of thin-coated cells 21 until the second state of charge decreases to a predetermined state of charge. The predetermined state of charge is a state of charge at which the plurality of thick-coated cells 22 can supply electric power to the drive source 2 in a certain period of time, and is, for example, 10%. As an example, when neither the accelerator nor the brake of the moving body S is being operated, the power control unit 322 charges the plurality of thin-coated cells 21 until the first charge rate of the plurality of thin-coated cells 21 reaches 100%, or until the second charge rate of the plurality of thick-coated cells 22 decreases to 10%.

By operating in this manner, the power control unit 322 can make it difficult to lower the state of charge of the plurality of thin-coated cells 21, which have lower energy density than the plurality of thick-coated cells 22, and can supply electric power to the drive source 2 from the plurality of thin-coated cells 21 at a high C rate. That is, in the energy storage device 10, the energy density and the C rate of the secondary battery such as lithium-ion batteries including the plurality of thin-coated cells 21 and the plurality of thick-coated cells 22 can be increased, thereby enabling both high energy density and high output characteristics to be achieved simultaneously.

### Processing Sequence in Energy Storage Device 10

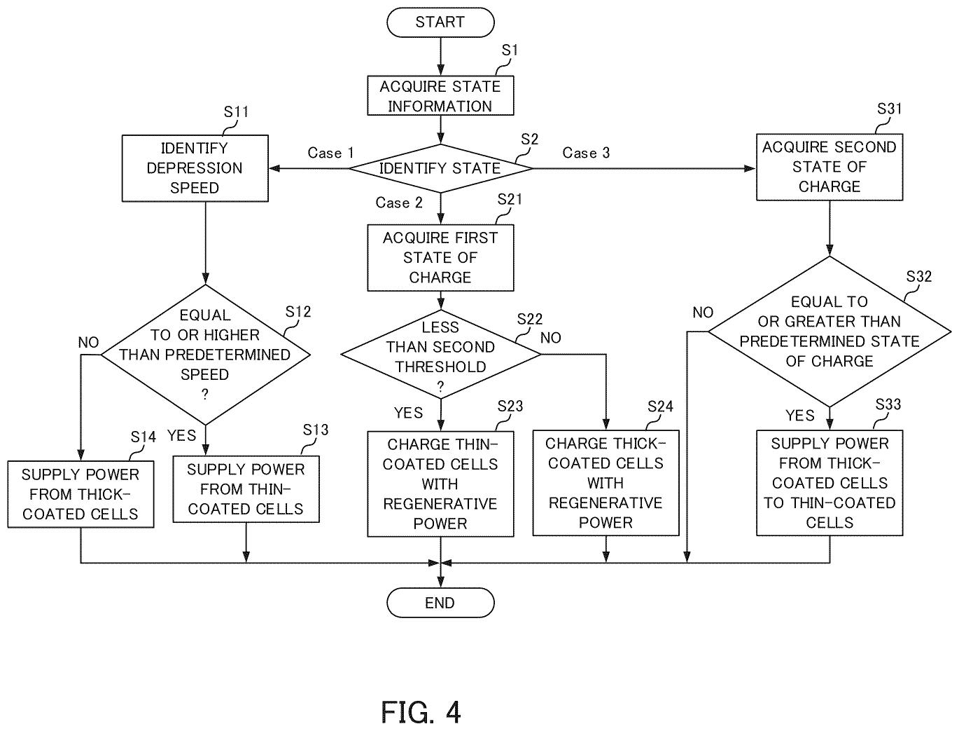

FIG. 4 is a diagram illustrating an example of a processing sequence in the energy storage device 10. The energy storage device 10 repeats the processing sequence shown in FIG. 4 at a predetermined interval. The acquisition unit 321 acquires state information indicating a state of the moving body S from the controller 1 (S1), and identifies the state of the moving body S (S2).

When the state of the moving body S is a state in which the accelerator pedal is depressed (Case 1 in S2), the power control unit 322 identifies a depression speed included in the state information acquired by the acquisition unit 321 (S11). If the depression speed is equal to or higher than the predetermined speed (YES in S12), the power control unit 322 causes a plurality of thin-coated cells 21 to supply electric power to the drive source 2 (S13), and ends the process. If the depression speed is less than the predetermined speed (NO in S12), the power control unit 322 causes a plurality of thick-coated cells 22 to supply electric power to the drive source 2 (S14), and ends the process.

When the state of the moving body S is a state in which a regenerative brake is in operation (Case 2 in S2), the power control unit 322 acquires a first state of charge from the acquisition unit 321 (S21). If the first state of charge is less than a second threshold value (YES in S22), the power control unit 322 charges the plurality of thin-coated cells 21 with electric power (so-called regenerative electric power) generated by the regenerative brake of the drive source 2 (S23), and ends the process. If the first state of charge is equal to or greater than the second threshold value (NO in S22), the power control unit 322 charges the plurality of thick-coated cells 22 with the regenerative power (S24), and ends the process.

When the state of the moving body S is neither the state in which the accelerator pedal is depressed nor the state in which the regenerative brake is in operation (Case 3 in S2), the power control unit 322 acquires a second state of charge from the acquisition unit 321 (S31). If the second state of charge is equal to or greater than the predetermined state of charge (YES in S32), the power control unit 322 charges the plurality of thin-coated cells 21 by supplying electric power from the thick-coated cells 22 to the plurality of thin-coated cells 21 (S33), and ends the process. If the second state of charge is less than the predetermined state of charge (NO in S32), the power control unit 322 ends the process.

### First Modification

In the above description, the configuration of the moving body S in which the controller 1 is provided outside the energy storage device 10 has been exemplified, but the configuration is not limited thereto. The energy storage device 10 may include the controller 1.

### Second Modification

In the above description, the configuration in which the energy storage device 10 includes the energy storage unit 20 and the energy storage control unit 30 has been exemplified, but the configuration is not limited thereto. The energy storage unit 20 and the energy storage control unit 30 may be provided in the moving body S as devices different from each other. For example, the energy storage unit 20 may be provided in the moving body S as an energy storage device and the energy storage control unit 30 may be provided in the moving body S as an energy storage control device. Furthermore, the energy storage control device may include the energy storage control unit 30 and the controller 1.

### Effects of the Energy Storage Device 10

As described above, the energy storage device 10 includes the plurality of thin-coated cells 21 to which the first active materials 26 having thicknesses within the first range are applied between the current collector 24 and the separator 25, and the plurality of thick-coated cells 22 to which the second active materials 27 having thicknesses within the second range whose lower limit value is greater than the upper limit value of the first range, are applied between the current collector 24 and the separator 25. The thin-coated cells 21 and the thick-coated cells 22 are alternately arranged at predetermined intervals.

Since the energy storage device 10 is configured in this manner, electric power can be supplied from the plurality of thin-coated cells 21 to the drive source 2 at a high C rate, and the plurality of thick-coated cells 22 can increase the energy density. As a result, the energy storage device 10 can improve energy density and output characteristics.

The present disclosure is explained based on the exemplary embodiments. The technical scope of the present disclosure is not limited to the scope explained in the above embodiments and it is possible to make various changes and modifications within the scope of the disclosure. For example, all or part of the device can be configured with any unit which is functionally or physically dispersed or integrated. Further, new exemplary embodiments generated by arbitrary combinations of them are included in the exemplary embodiments. Further, effects of the new exemplary embodiments brought by the combinations also have the effects of the original exemplary embodiments.

What is claimed is:

1. An energy storage device mounted in a moving body, the energy storage device comprising:
a plurality of first cells to which first active materials having thicknesses within a first range are applied between a current collector and a separator; and
a plurality of second cells to which second active materials having thicknesses within a second range whose lower limit value is greater than an upper limit value of the first range, are applied between the current collector and the separator, wherein the first cells and the second cells are alternately arranged at predetermined intervals.

2. The energy storage device according to claim 1, further comprising:
an acquisition unit that acquires state information indicating a state of the moving body, a first state of charge of the plurality of first cells, and a second state of charge of the plurality of second cells; and
a power control unit that controls (i) charging of the plurality of first cells and the plurality of second cells and (ii) supply of electric power to a drive source of the moving body, on the basis of at least one of the state information, the first state of charge, or the second state of charge.

3. The energy storage device according to claim 2, wherein, on condition that the acquisition unit has acquired the state information indicating a depression speed at which an accelerator pedal of the moving body is depressed, the power control unit causes the plurality of first cells to supply electric power to the drive source when the depression speed exceeds a predetermined speed, and causes the plurality of second cells to supply electric power to the drive source when the depression speed is equal to or less than the predetermined speed.

4. The energy storage device according to claim 2, wherein the power control unit causes the plurality of first cells to supply electric power to the drive source in accordance with a depression speed when the acquisition unit acquires the state information indicating the depression speed at which an accelerator pedal of the moving body is depressed and the second state of charge is equal to or less than a first threshold value.

5. The energy storage device according to claim 2, wherein, on condition that the acquisition unit has acquired the state information indicating a state in which a regenerative brake of the moving body is in operation, the power control unit charges the plurality of first cells with electric power generated by the regenerative brake when the first state of charge is less than a second threshold value, and charges the plurality of second cells with the electric power when the first state of charge is equal to or greater than the second threshold value.

6. The energy storage device according to claim 2, wherein, on condition that the acquisition unit has not acquired the state information indicating a state in which an accelerator pedal of the moving body is depressed or a state in which a regenerative brake of the moving body is in operation, the power control unit charges the plurality of first cells by supplying electric power from the plurality of second cells to the plurality of first cells.

7. The energy storage device according to claim 6, wherein the power control unit charges the plurality of first cells by supplying electric power from the plurality of second cells to the plurality of first cells until the second charge rate decreases to a predetermined charge rate when the first charge rate is less than a second threshold value.

8. The energy storage device according to claim 2, wherein the power control unit causes the plurality of second cells to supply electric power to the drive source at the maximum value of outputs of the plurality of second cells when the first state of charge is equal to or less than a first threshold value, even when a depression speed of an accelerator pedal of the moving body included in the state information exceeds a predetermined speed.

9. An energy storage system comprising:
an energy storage device, which includes lithium-ion batteries and is mounted in a moving body; and
an energy storage control device that controls charging and power supply of the energy storage device, wherein the energy storage device includes:
a plurality of first cells to which first active materials having thicknesses within a first range are applied between a current collector and a separator; and
a plurality of second cells to which second active materials having thicknesses within a second range, whose lower limit value is greater than an upper limit value of the first range, are applied between the current collector and the separator, among which the first cells and the second cells are alternately arranged at predetermined intervals, and the energy storage control device includes:
an acquisition unit that acquires state information indicating a state of the moving body, a first state of charge of the plurality of first cells, and a second state of charge of the plurality of second cells; and
a power control unit that controls (i) charging of the plurality of first cells and the plurality of second cells and (ii) supply of electric power to a drive source of the moving body, on the basis of at least one of the state information, the first state of charge, or the second state of charge.
